(19) United States
(12) Patent Application Publication
(10) Pub. No.: US 2020/0098010 A1
(43) Pub. Date: Mar. 26, 2020

(54) SYSTEM AND METHOD FOR PROVIDING RECOMMENDATIONS BASED ON CONSUMER LOCATION

(71) Applicant: PAG Financial International LLC, Guaynabo, PR (US)

(72) Inventors: Pavan Agarwal, Cerritos, CA (US); Jonathan Ortiz Rivera, Cerritos, CA (US); Gabriel Albors Sanchez, Cerritos, CA (US)

(21) Appl. No.: 16/137,460

(22) Filed: Sep. 20, 2018

(51) Int. Cl. G06Q 30/02

(52) U.S. Cl. CPC G06Q 30/0269; G06Q 30/0261

(57) ABSTRACT

Systems and methods are provided for providing for providing location specific recommendations related to promotional advertisements provided by merchants in a geolocation. Merchants and consumers may utilize recommendation platforms that allow consumers to receive recommendations generated based on consumer and other information related to promotional advertisements from merchants occupying the same geolocation as consumers. A recommendation can be a suggestion or advice for a particular promotional advertisement selected from all of the promotional advertisements provided by merchants occupying the same geolocation as consumers. A merchant may input information associated with and/or relevant to the merchant. A consumer may input information associated with and/or relevant to the consumer. The recommendation may be generated based on the obtained geolocation information, merchant information, and consumer information.

### TECHNICAL FIELD

The present disclosure is generally related to recommendation platforms. More particularly, the present disclosure is directed to systems and methods for providing recommendations generated based on consumer information at a geolocation from local merchants on mobile communications devices.

### BACKGROUND

Business owners are often looking for new and innovative ways to promote their goods, services, and provide other relevant information to consumers. Different platforms can be utilized by merchants seeking to provide location-based promotional advertisements to consumers seeking to obtain a desired service(s) and/or product(s). Some of these platforms facilitate distributing location-based promotional advertisements to consumers from all merchants that meet a certain criteria, e.g., a location.

### SUMMARY

In accordance with one or more embodiments, various features and functionality can be provided to enable or otherwise facilitate providing location-specific recommendations based on consumer provided information. Embodiments disclosed herein relate to systems and methods for providing location specific recommendations related to promotional advertisements provided by merchants in a geolocation based on consumer provided information.

One aspect of the disclosure relates to a system configured to analyze promotional advertisements or offers provided to consumers by business owners located in the same geographical area as the business owners. Rather than receiving a plurality of advertisements from all participating business owners, consumers at a geolocation may seek to receive only those promotional advertisements that are relevant to them. Merchants and consumers may utilize recommendation platforms that allow consumers to receive recommendations generated based on consumer and other information related to promotional advertisements from merchants occupying the same geolocation as consumers.

A recommendation can be some form of a suggestion or advice for a particular promotional advertisement selected from all of the promotional advertisements provided by merchants occupying the same geolocation as consumers. For example, recommendations can suggest that a particular promotional offer from a merchant may be preferred by a consumer based on consumer provided information. Recommendations may be location specific and may include an estimated value individual recommendation holds for the consumer. Recommendations may be ordered based on the estimated value. Recommendation may include preference indicators quantifying the value estimate, which will be discussed in greater detail below.

A merchant may register and set up a merchant account with a recommendation platform. The merchant may input information associated with and/or relevant to the merchant, such as merchant information specifying details associated with merchant products and/or services, promotional information specifying promotional advertisements available for specific merchant's products and/or services, consumer attributes of users to whom promotions may be distributed, and/or geographical distribution information specifying geolocations in which promotions may be distributed to consumers, which will be discussed in greater detail below.

A consumer may register and set up a user subscriber account with the recommendation platform. The consumer may input information associated with and/or relevant to the consumer, such as consumer information specifying consumer demographic characteristics; products and/or services the consumer may be interested in receiving, by either specifying types or categories of products or services, types of merchants delivering those products and/or services, or both; promotional information specifying types or levels of promotional advertisements the consumer may be interested in, specific merchants from whom the consumer is interested in receiving promotional offers from; and/or geographical distribution information specifying a geolocation of the consumer where promotional advertisements may be received.

The recommendation platform may be configured to track movements of the consumer using a mobile computing device, which is equipped with a GPS, such that consumer may receive recommendations for promotional advertisements from the merchant that distributes promotions for goods and/or services in the same geolocation.

The geolocation information may be used by the recommendation platform to determine, in accordance with the location preferences specified by the consumer, whether the geolocation of the consumer satisfies the location preferences provided by the consumer.

The system may be configured by machine-readable instructions to obtain merchant information inputted by the merchant either alone or in conjunction with a database. The merchant information inputted by the merchant may include details about the merchant and its business (e.g., location, hours of operation, website, and so on) and the types, categories and/or other such information related to products and/or services the merchant provides.

The system may be configured by machine-readable instructions to obtain promotional information specifying promotional advertisements available for specific merchant's products and/or services.

The system may be configured by machine-readable instructions to obtain consumer information inputted by the consumer either alone or in conjunction with the database. The consumer information may include details about the consumer such as demographic information including age, sex, race, and so on, specify consumer preferences including types, categories and/or other such information related to products and/or services the consumer may be interested in. In some embodiments, the system may be configured by to obtain consumer information related to consumer's account on one or more social media platforms.

The system may be configured by machine-readable instructions to generate recommendations based on the obtained geolocation information, merchant information, and consumer information. The recommendations may include some or all of the promotional advertisements the consumer may be interested in. The system may be configured to generate recommendations from a number of available promotional advertisements provided by merchants in a geolocation. The recommendations may be determined by utilizing a variety of analytical techniques to analyze collected sets of merchant information and consumer information. Recommendations may be ranked by including a preference indicator associated with each recommendation and/or include a preference indicator associated with individual recommendations.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates a system configured to provide real-time recommendations to users, in accordance with embodiments disclosed herein.

FIGS. 2A-2C illustrates various examples of recommendations provided at various geolocations, in accordance with embodiments disclosed herein.

FIG. 3 is an example computing component that may be used in implementing various features of embodiments of the disclosed technology, in accordance with embodiments disclosed herein.

FIG. 4 illustrates an example recommendation system, in accordance with embodiments disclosed herein.

FIG. 5 illustrates an example consumer user interface through which recommendations may be presented, in accordance with embodiments disclosed herein

FIG. 6. is flow chart illustrating various operations that may be utilized in providing recommendations, in accordance with embodiments disclosed herein.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### DETAILED DESCRIPTION

The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

Business owners may seek to provide promotional advertisements or offers to consumers that are located in the same geographical area as the business owners. Rather than receiving a plurality of advertisements from all participating business owners, consumers at a geolocation may seek to receive only those promotional advertisements that are relevant to them. For example, there could be dozens of participating merchants providing promotional offers related to their products or services at a particular geolocation. Consumers receiving promotional advertisements of all businesses at a geolocation may become overwhelmed and fail to accept or inadvertently miss any such advertisement. Accordingly, this non-specific way of providing consumers with promotional advertisements may render merchant's promotional activity unsuccessful. Likewise, obscuring relevant promotional advertisements in a list of unrelated offers may cause consumers to miss desirable offers. Merchants and consumers may utilize recommendation platforms that allow consumers to receive recommendations generated based on consumer and other information related to promotional advertisements from merchants occupying the same geolocation as consumers.

It should be noted that although the disclosure may describe embodiments in the context of a recommendation platform, recommendations can be provided to consumers irrespective of how merchants may provide the advertisements, and/or any particular recommendation platform utilized by consumers.

A recommendation generated by recommendation platform 107 can be some form of a suggestion or advice for a particular promotional advertisement selected from all of the promotional advertisements provided by merchants occupying the same geolocation as consumers. For example, the recommendation can suggest that one promotional advertisement from a merchant may be preferred by a consumer over another promotional advertisement. That is, if a consumer has indicated that he or she is interested in completing a home remodeling project that consumer may receive a recommendation that includes a “deal” on home building supplies from a merchant located near consumer's home. Recommendations may be location specific. That is, recommendations received by consumers will be associated with promotional offers from merchants located at the same geolocation. Recommendations may include an estimated value individual recommendation holds for the consumer. For example, a recommendation for a mortgage with a lower rate may hold a higher value to the consumer looking to refinance their home. Recommendations may be ordered based on the estimated value. Recommendation may include preference indicators quantifying the value estimate, which will be discussed in greater detail below.

Embodiments disclosed herein relate to systems and methods for providing location specific recommendations related to promotional advertisements provided by merchants in a geolocation based on consumer provided information.

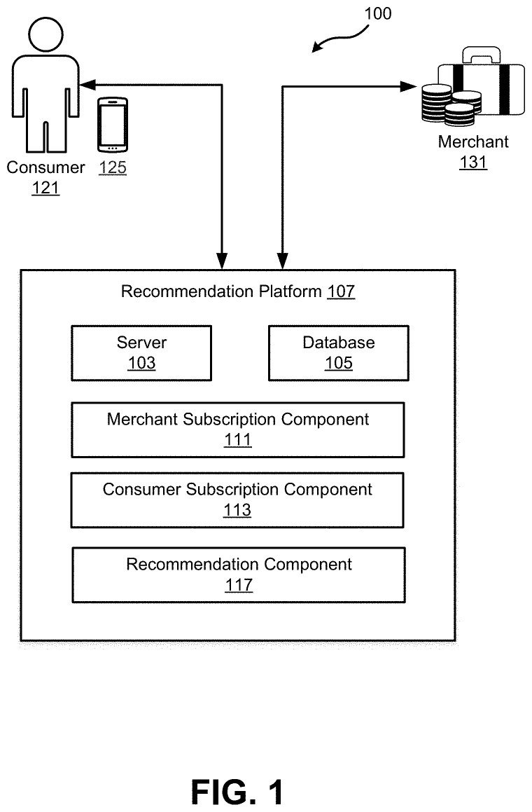

FIG. 1 illustrates an example recommendation system 100. Merchant 131 may register and set up a merchant account with recommendation platform 107. Merchant 131 may create a page on a website or a mobile application hosted by server 103 of recommendation platform 107. Merchant 131 may input information associated with and/or relevant to merchant 131 via merchant subscription component 111, such as merchant information specifying details associated with merchant products and/or services, promotional information specifying promotional advertisements available for specific merchant's products and/or services, consumer attributes of users to whom promotions may be distributed, and/or geographical distribution information specifying geolocations in which promotions may be distributed to consumers, which will be discussed in greater detail below.

Consumer 121 may register and set up a user subscriber account with recommendation platform 107. Consumer 121 may input information associated with and/or relevant to consumer 121 via consumer subscription component 113, such as consumer information specifying consumer demographic characteristics; products and/or services consumer 121 may be interested in receiving, by either specifying types or categories of products or services, types of merchants delivering those products and/or services, or both; promotional information specifying types or levels of promotional advertisements consumer 121 may be interested in, specific merchants from whom consumer 121 is interested in receiving promotional offers from; and/or geographical distribution information specifying a geolocation of consumer 121 where promotional advertisements may be received. Through the page created by merchant 131, consumer 121 may identify merchant 131 as a business entity that consumer 121 is interested in. For example, if merchant 121 is a realtor, consumer 121 may identify merchant 131 as a business entity consumer 121 is interested in receiving promotional offers from. Alternatively, consumer 121 may identify specific products or services consumer 121 is interested in receiving promotional offers on. For example, consumer may identify mortgage loan products as a category of services that consumer 121 is interested in receiving promotional offers from merchant 131.

Recommendation platform 107 may be configured to track movements of consumer 121 using mobile computing device 125, which is equipped with a GPS, such that consumer 121 may receive recommendations for promotional advertisements from merchant 131 that distributes promotions for merchant 131 goods and/or services in the same geolocation. Geolocations of consumer 121 may be tracked, for example via the GPS. Movements of consumer 121 may be tracked in real-time. For example, as consumer 121 moves from one location to another, the recommendations for promotional advertisements may change based on consumer 121 geolocation. That is, the recommendations for promotional advertisements received at a first geolocation may be generated in part in response to a merchant providing goods and/or services at the first geolocation. Similarly, recommendations for promotional advertisements received at a second geolocation may be generated in part in response to another merchant providing goods and/or services at the second geolocation. The merchant providing goods and/or services at the first geolocation may or may not be the same merchant providing goods and/or services at the second geolocation.

Mobile computing device 125 of consumer 121 may be equipped with GPS location tracking and may transmit geolocation information via a wireless link and a communications network to recommendation platform 107 of system 100. Recommendation platform 107 may use the geolocation information to determine a geolocation of consumer 121. System 100 may use signal transmitted by mobile computing device 125 to determine the geolocation of consumer 121 based on one or more of signal strength, GPS, cell tower triangulation, Wi-Fi location, or other input. In some implementations, movements of consumer 121 may be tracked using a geography-based transmitter on mobile computing device 125.

In some implementations, consumer 121 may be traveling in a motor vehicle or other means of transportation. Accordingly, recommendation platform 107 may obtain geolocation information comprising of a direction of travel and/or speed with which consumer 121 is traveling. Further still, in some implementations, recommendation platform 107 may obtain the geolocation information directly from consumer 121. For example, recommendation platform 107 may request consumer 121 to provide a street address or enter other location identifying attributes, such as prominent landmarks.

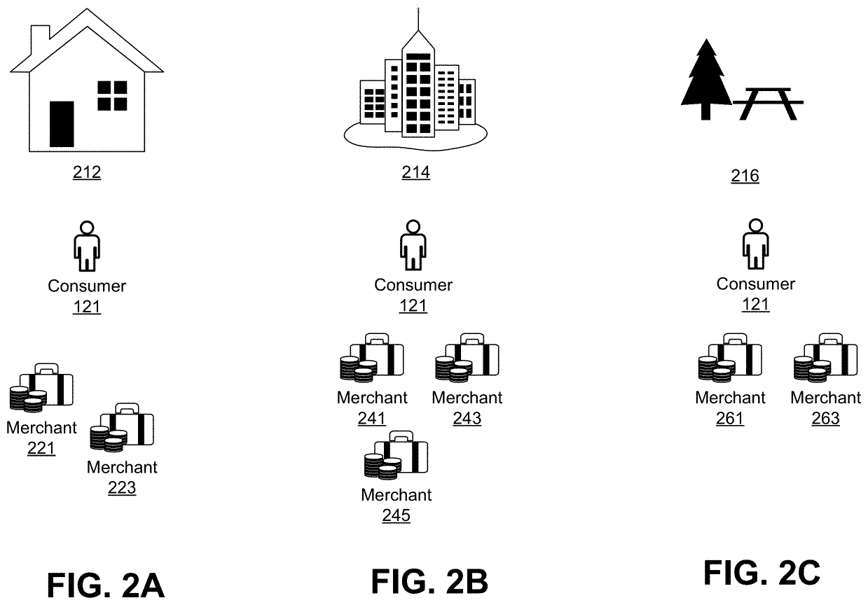

The geolocation information corresponding to the geolocation of consumer 121 transmitted from mobile computing device 125 may be processed by recommendation platform 107. The geolocation information may be processed by recommendation platform 107 in accordance with location and other parameters provided by consumer 121. For example, consumer 121 may provide a set of geolocations that are desirable or preferred for consumer 121 (e.g., a location near consumer's home or place of employment, and so on), as further illustrated in FIGS. 2A-2C.

The geolocation information may be used by recommendation platform 107 to determine, in accordance with the location preferences specified by consumer 121, whether the geolocation of consumer 121 satisfies the location preferences provided by consumer 121. For example, if consumer 121 enters an area at or near consumer 121 place of employment, recommendation platform 107 will determine that consumer 121 geolocation satisfies the location preference provided by consumer 121.

The determination that consumer 121 geolocation satisfies the location preference provided by consumer 121, may cause recommendation platform 107 to generate a recommendation (as will be discussed in greater detail below). In some embodiments, recommendation platform 107 may generate a notification transmitted from recommendation platform 107 via a wireless link and a communications network to mobile computing device 125 of consumer 121. The notification transmitted to consumer 121 may inform consumer 121 of that they have entered a geolocation that satisfied the location preference and/or inform consumer 121 that recommendation has been generated by recommendation platform 107. Accordingly, the notification may also include consumer 121 geolocation, time, and a recommendation generated by recommendation platform 107.

For example, and as illustrated in FIGS. 2A-2C, consumer 121 may move between geolocation 212 (illustrated in FIG. 2A), geolocation 214 (illustrated in FIG. 2B), and geolocation 216 (illustrated in FIG. 2C). The recommendations provided by recommendation component 117 of recommendation platform 107 (illustrated in FIG. 1) may be reflective of merchants operating at each of location 212, 214, and 216.

For example, as illustrated in FIG. 2A, geolocation 212 may be consumer 121 home. Merchant 221 and merchant 223 may be subscribed merchants of system 100 and operating at geolocation 212 may be a restaurant and a car wash business respectively. Consumer 121 may be subscribed to receive recommendations for promotional advertisements from businesses operating a restaurant and a car wash near consumer 121 home (i.e., at geolocation 212). Upon entering geolocation 212, consumer 212 may receive recommendations from merchant 221 and 223 for promotional advertisements for meal or drink special or car detailing servicers, respectively.

In another example illustrated in FIG. 2B, geolocation 214 may be consumer 121 place of employment. At geolocation 214, merchants 241-245 may be operating their respective businesses (e.g., a sporting goods retailer, a coffee vendor, and a bank). Merchants 241-245 may be subscribed merchants of system 100. Consumer 121 may be subscribed to receive recommendations for promotional advertisements from businesses operating a coffee shop and a bank near consumer 121 place of employment (i.e., at geolocation 214). Additionally, consumer 121 may be subscribed to receive recommendations for promotional advertisements from businesses operating a bank for a home refinance loan at a certain rate. Accordingly, upon entering geolocation 214, consumer 121 may receive recommendations for a free coffee with a purchase of a lunch from merchant 243 and recommendations for a mortgage loan for a home buyer with a high credit score from merchant 245. Consumer 121 may qualify to receive recommendations for a mortgage loan for a home buyer with a high credit score from merchant 245 because consumer 121 has included information related to his or her credit score via consumer subscription component 113 (as discussed herein). Finally, because consumer 121 is not interested in sports, no recommendations will be provided from merchant 241, a sporting goods retailer.

Finally, as illustrated in FIG. 2C, geolocation 216 may be visited by consumer 121 while on vacation. At geolocation 214, merchants 261 and 265 may be operating their respective businesses (e.g., a car rental agency and a tour guide operator). Merchants 261 and 263 may be subscribed merchants of system 100. Consumer 121 may be subscribed to receive recommendations for promotional advertisements on car rentals and tours at geolocation 216. Additionally, consumer 121 may be subscribed to receive recommendations for promotional advertisements on half-day tours only. Accordingly, upon entering geolocation 216, consumer 121 may receive recommendations for a one-day free car rental with a purchase of week-long rental agreement from merchant 261 and recommendations for a 30-minute guided cathedral tour with a purchase of a half-day city tour from merchant 263. Because consumer 121 is not interested in tours longer than one day, no recommendations will be provided from merchant 241 for tours exceeding the half-day time period.

Referring back to FIG. 1, merchant subscription component 111 may handle merchant information inputted by merchant 131 either alone or in conjunction with database 105. For example, a user interface may be provided via merchant subscription component 111 allowing merchant 131 to input the merchant information. The merchant information provided by merchant 131 via merchant subscription component 111 may be provided to recommendation component 117. The merchant information inputted by merchant 131 may include details about merchant 131 and its business (e.g., location, hours of operation, website, and so on). The merchant information inputted by merchant 131 may further specify the types, categories and/or other such information related to products and/or services merchant 131 distributes. For example, merchant 131 which is a financial lender may include information on the types of secured or unsecured lending instruments merchant 131 provides.

In some embodiments, merchant 131 may input the merchant information specifying additional details related to each product and/or service. For example, a mortgage lender merchant 131 may input details for a loan including interest rate, qualification requirements, approximate monthly payment information associated, and so on.

Merchant 131 may input promotional information specifying promotional advertisements available for specific merchant's products and/or services. For example, merchant 131 may include an offer including a special interest rate for consumers with a high credit score. The promotional information may include additional information regarding consumers to whom these promotional advertisements may be distributed (e.g., only consumers that have a high credit score). Merchant 131 may include geographical distribution information specifying geolocations in which promotions may be distributed. For example, only consumers present in geolocation occupied by merchant 131 may be able to receive recommendations for promotional advertisements of that merchant.

Merchant 131 may add, modify, and/or remove the merchant information inputted by merchant 131. Such changes can be input via merchant subscription component 111 and reflected in its local memory and/or database 105.

Consumer subscription component 113 may handle consumer information inputted by consumer 121 either alone or in conjunction with database 105. For example, a user interface may be provided via consumer subscription component 113 allowing consumer 121 to input consumer information. The consumer information provided by consumer 121 via consumer subscription component 113 may be provided to recommendation component 117. The consumer information inputted by consumer 121 may include details about consumer 121 such as demographic information including age, sex, race, and so on. The consumer information inputted by consumer 121 may further specify consumer preferences including types, categories and/or other such information related to products and/or services consumer 121 may be interested in. For example, consumer 121 may include information on the types of restaurants he or she prefers, the type of homes he or she is interested in buying or renting, and/or other such preferences.

In some embodiments, consumer subscription component 113 may provide a set of questions to consumer 121 that may be used by recommendation engine in determining what promotion or offers are best suited for consumer 121. For example, consumer 121 may be asked to list the activities or types of activities they like to engage in, locations or types of locations they frequent, food and beverage preferences and/or aversions, and so on.

In some embodiments, consumer 121 may input information related to consumer 121 account on one or more social media platforms via consumer subscription component 113. For example, consumer 121 may have accounts with one or more social media platform including Facebook®, LinkedIn® Twitter®, YouTube®, Yelp®, and so on. The information related to consumer's social media platforms may include interaction history between consumer 121 and one or more merchants, messages made by consumer 121 specifying consumer 121 preferences, and so on. The information related to consumer 121 social media platforms may be extracted and stored in database 105.

Recommendations provided to consumer 121 may be generated by recommendation component 117 based on geolocation information obtained by recommendation platform 107, information received from merchant subscription component 111, and information received from consumer subscription component 113.

Recommendation component 117 may generate recommendations for consumer 121 at a geolocation. The recommendations may comprise promotional advertisements obtained from merchant subscription component 111 at a geolocation. The recommendations may include some or all of the promotional advertisements consumer 121 may be interested in and may be based on consumer information received from consumer subscription component 113 including consumer 121 demographic information, consumer 121 preferences including types, categories and/or other such information related to products and/or services consumer 121 may be interested in, answers to questions consumer 121 inputted into consumer subscription component 113, and/or consumer 121 social media information obtained by consumer subscription component 113 through accessing information related to consumer's social media accounts on one or more social media platforms.

For example, consumer 121 may input that he or she is interested in buying a new home at or near their place of employment. Additionally, consumer 121 may indicate that they have a spouse and two young children and an above average credit score. In response to questions provided by consumer subscription component 113, consumer 121 may input that they prefer single story homes to multi-story homes. Finally, consumer subscription component 113 may obtain information from consumer 121 Facebook® profile, where they indicate that they “like” Shea Homes® builders and modern furniture style. Upon entering a geolocation associated with consumer 121 place of employment, recommendation component 117 may generate recommendations, including promotional advertisements from real estate agents of single story homes at the geolocation at or near consumer 121 place of employment. Additionally, recommendation component 117 may generate recommendations, including promotional advertisements from lenders offering attractive rates to potential home buyers with a higher than average credit score. Finally, recommendation component 117 may generate recommendations including promotional advertisements from furniture retailers specializing in modern furniture.

Recommendation component 117 may generate recommendations from a number of available promotional advertisements inputted by merchants via merchant subscription component 111 in a geolocation. For example, there could be five real estate listings for a home near the geolocation of consumer 121 place of employment. However, only two listings will be for a single-story home and only one will have a large back yard. Based on the consumer information provided to recommendation component 117 by consumer subscription component 113, the recommendation will be limited only to single story home with a large backyard, as that is the option fitting a family with two small children. Consumer 121 will be able to view all promotional advertisements that were not part of recommendation generated by recommendation component 117.

Recommendations generated by recommendation component 117 may rank the generated recommendations by including a preference indicator associated with each recommendation. For example, a recommendation for a single-story home with a large backyard may be ranked higher than a recommendation for a single-story home without a large backyard.

Recommendation component 117 may include a preference indicator associated with individual recommendations based on promotional advertisements in accordance with consumer information, including consumer demographic information, consumer preferences including types, categories and/or other such information related to products and/or services consumer may be interested in, answers to questions provided by the consumer, and/or social media information related to consumer's social media accounts on one or more social media platforms. The preference indicator may be a sliding scale of percentile values (e.g., 10%, 15%, . . . n, where a percentage may reflect a degree of preference), numerical values (e.g., 1, 2, . . . n, where a number may be assigned as low and/or high), verbal levels (e.g., very low, low, medium, high, very high, and/or other verbal levels), and/or any other scheme to represent a preference score.

Recommendation component 117 may determine each recommendation by utilizing a variety of analytical techniques to analyze collected sets of merchant information and consumer information to generate a preference indicator. For example, recommendation component 117 may utilize Bayesian-type statistical analysis to determine the preference indicator for each recommendation. The preference indicator may be a quantified likelihood of a consumer being satisfied with a recommendation.

In some implementations, recommendation component 117 may analyze geolocation information obtained by recommendation platform 107, information received from merchant subscription component 111, and information received from consumer subscription component 113 in conjunction with one or more predictive models. The predictive models may include one or more of neural networks, Bayesian networks (e.g., Hidden Markov models), expert systems, decision trees, collections of decision trees, support vector machines, or other systems known in the art for addressing problems with large numbers of variables. Specific information analyzed during the recommendation generation may vary depending on the desired functionality of the particular predictive model.

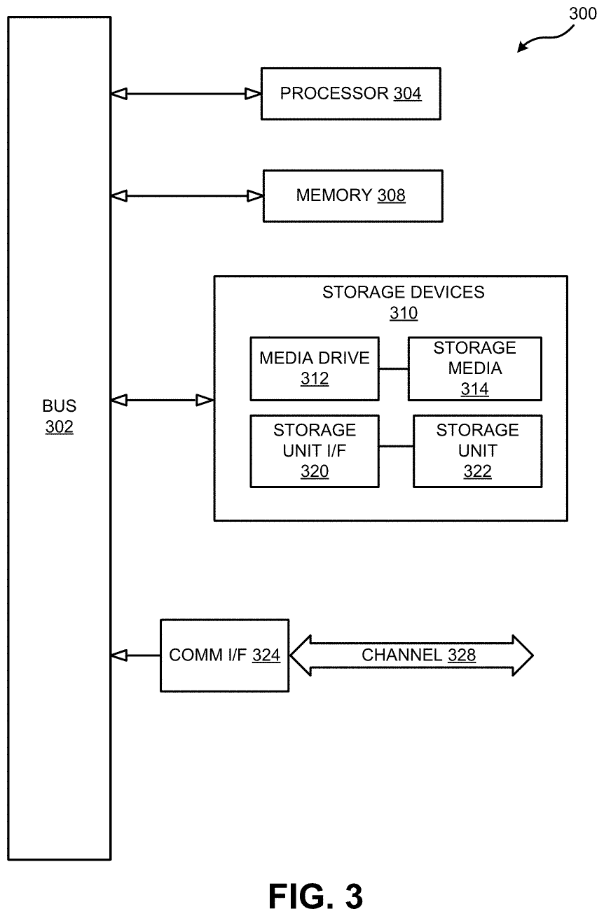

FIG. 3 illustrates an example computing component that may be used to implement various features of the system and methods disclosed herein, for example, recommendation platform 107, server 103, merchant subscription component 111, user subscription component 113, recommendation component 117, and/or one or more elements comprising these components.

As used herein, the term component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. In implementation, the various components described herein might be implemented as discrete components or the functions and features described can be shared in part or in total among one or more components. In other words, as would be apparent to one of ordinary skill in the art after reading this disclosure, the various features and functionality described herein may be implemented in any given application and can be implemented in one or more separate or shared components in various combinations and permutations. Even though various features or elements of functionality may be individually described or claimed as separate components, one of ordinary skill in the art will understand that these features and functionality can be shared among one or more common software and hardware elements, and such description shall not require or imply that separate hardware or software components are used to implement such features or functionality.

Where components are implemented in whole or in part using software, in one embodiment, these software elements can be implemented to operate with a computing or processing component capable of carrying out the functionality described with respect thereto. One such example computing component is shown in FIG. 3. Various embodiments may be described in terms of this example computing component 300. After reading this disclosure, it will become apparent to a person skilled in the relevant art how to implement the application using other computing components or architectures.

Computing component 300 may represent, for example, computing or processing capabilities found within a desktop, laptop, notebook, and tablet computers; hand-held computing devices (tablets, PDA's, smart phones, cell phones, palmtops, etc.); workstations or other devices with displays; servers; or any other type of special-purpose or general-purpose computing devices as may be desirable or appropriate for a given application or environment. Computing component 300 might also represent computing capabilities embedded within or otherwise available to a given device. For example, a computing component might be found in other electronic devices such as, for example, portable computing devices, and other electronic devices that might include some form of processing capability.

Computing component 300 might include, for example, one or more processors, controllers, control components, or other processing devices, such as a processor 304. Processor 304 might be implemented using a general-purpose or special-purpose processing engine such as, for example, a microprocessor, controller, or other control logic. In the illustrated example, processor 36 is connected to a bus 302, although any communication medium can be used to facilitate interaction with other components of computing component 300 or to communicate externally.

Computing component 300 might include one or more memory components, simply referred to herein as memory 38. For example, preferably random access memory (RAM) or other dynamic memory, might be used for storing information and instructions to be executed by processor 304. Memory 308 might be used for storing temporary variables or other intermediate information during execution of instructions, such as machine-readable instructions, to be executed by processor 304. Computing component 300 might include a read only memory (“ROM”) or other static storage device coupled to bus 302 for storing static information and instructions for processor 304.

The computing component 300 might include one or more various forms of information storage mechanisms 310, which might include, for example, a media drive 312. The media drive 312 might include a drive or other mechanism to support fixed or removable storage media 314. For example, a hard disk drive, a solid-state drive, a magnetic tape drive, an optical disk drive, a compact disc (CD) or digital video disc (DVD) drive (R or RW), or other removable or fixed media drive might be provided. Accordingly, storage media 44 might include, for example, a hard disk, an integrated circuit assembly, magnetic tape, cartridge, optical disk, a CD or DVD, or other fixed or removable medium that is read by, written to or accessed by media drive 312. As these examples illustrate, the storage media 314 can include a computer usable storage medium having stored therein computer software or data.

Computing component 300 might include other similar instrumentalities for allowing computer programs or other instructions or data to be loaded into computing component 300. Such instrumentalities might include, for example, a fixed or removable storage unit 322 and an interface 320. Examples of such storage units 322 and interfaces 320 can include a program cartridge and cartridge interface, a removable memory (for example, a flash memory or other removable memory component) and memory slot, a PCMCIA slot and card, and other fixed or removable storage units 322 and interfaces 320 that allow software and data to be transferred from the storage unit 322 to computing component 300.

Computing component 300 might include a communications interface 324. Communications interface 324 might be used to allow software and data to be transferred between computing component 300 and external devices. Examples of communications interface 324 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 324 might typically be carried on signals, which can be electronic, electromagnetic (which includes optical) or other signals capable of being exchanged by a given communications interface 324. These signals might be provided to communications interface 324 via a channel 328. This channel 328 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 308, storage unit 322, media 314, and channel 328. These and other various forms of computer program media or computer usable media may be involved in carrying one or more sequences of one or more instructions to a processing device for execution. Such instructions embodied on the medium, are generally referred to as “machine-readable code,” “computer program code” or a “computer program product” (which may be grouped in the form of computer programs or other groupings). When executed, such instructions might enable the computing component 32 to perform features or functions of the disclosure as discussed herein.

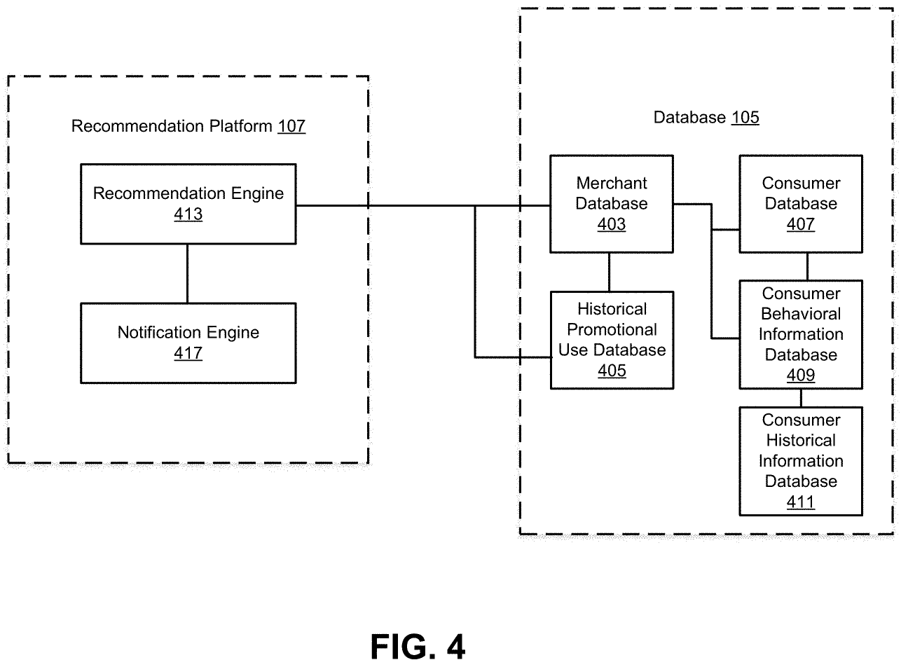

FIG. 4 illustrates elements that may make up recommendation component 117 and database 105. The elements in FIG. 4 are described in conjunction with each other and in the context of system 100 (see FIG. 1) for ease of explanation.

Database 105 may include merchant database 403 and historical promotional use database 405. It should be noted that the elements and/or functionality of database 105 may be implemented in local memory resident in merchant subscription component 111 or shared between database 105 and the local memory of merchant subscription component 111.

As indicated previously, merchant subscription component 111 may transmit merchant information, e.g., details related to a merchant; promotional information specifying promotional advertisements available for specific merchant products and/or services; consumer preference information specifying details related to consumers merchant 131 is offering its promotional advertisements to; and geographical distribution information specifying geolocations in which promotions may be distributed for storage in database 105. Database 105 may be populated with merchant information and/or promotional information.

Merchant information characterizing merchant 131 can be data reflecting merchant's name, address, website, hours of operation, etc. For example, a merchant that is a lender may include merchant information such as a name of a lending institution, a street address, hours of operation, and a URL pointing to a website operated by the merchant. Merchant information may reflect products and/or services the merchant 131 may be offering to consumers. Promotional information can reflect promotional advertisements merchant 131 wishes to offer to consumers. Consumer preference information can reflect a desired consumer to whom merchant 131 wishes to offer its promotional advertisements. For example, only consumers with certain demographic characteristics may be able to receive promotions on mortgage loans. Over time, consumer preference information can include information regarding the types of promotional advertisements merchant 131 has inputted that have been accepted by consumer 121.

The records maintained in merchant database 403 (which can be thought of as current data) can be transferred to historical promotional use information database 405. Historical promotional use information database 405 can reflect, e.g., revenue generated from a type of promotional advertisement or a frequency at which consumer 121 accepted promotional advertisements, etc.

Database 105 may include consumer database 407. Consumer information reflecting information characterizing one or more aspects of consumers may be stored in consumer database 407. Consumer 121 may be one such consumer. Upon registering with recommendation platform 107, consumer 121 may input certain demographic information indicative of economic and/or social characteristics of consumer 121. For example, consumer information may reflect the yearly income of consumer 121, a geographic area in which consumer 121 resides and/or works, the age of consumer 121, interests of consumer 121, etc. Consumer information can include information regarding products and services consumer 121 may be interested in. Consumer information can include information regarding specific merchants that consumer 121 is interested in receiving products or services from. Further, consumer information can include information regarding types of promotions, e.g., level of discount, consumer 121 may be interested in. Over time, consumer information can include information regarding the types of promotional advertisements consumer 121 has accepted.

Database 105 may include consumer behavioral information database 409. Consumer behavioral information reflecting information characterizing consumer 121 social interactions on one or more social media platforms may be stored in consumer database 409. Consumer 121 may provide access to one or more social platforms upon registering with recommendation platform 107. Social media information may include consumer 121 affiliations. For example, consumer 121 may indicate which products or services consumer 121 interacts with via one or more social media platforms (e.g., interactions may include by liking, providing comments, sharing, and so on).

The records maintained in consumer database 407 (which can be thought of as current data) can be transferred to consumer historical information database 411. Consumer historical information database 411 can include information which indicates the types of promotional advertisements consumer 121 has accepted and the merchants associated with each promotion or offer accepted by consumer 121.

Recommendation component 117 may comprise recommendation engine 413 and notification engine 417 for generating recommendations for and reporting the recommendations and other related information (e.g., consumer historical information and historical promotional use information) to consumer 121, merchant 131 and/or recommendation platform 107.

Recommendation engine 413 may be configured to determine initial and/or all promotional advertisements provided by merchant 131 at a geolocation. Recommendation engine 413 may obtain merchant information, e.g., details related to a merchant; promotional information specifying promotional advertisements available for specific merchant products and/or services; consumer preference information specifying details related to consumers merchant 131 is offering its promotional advertisements to; and geographical distribution information specifying geolocations in which promotions may be distributed from one or more of databases 403-405. For example, recommendation engine 413 may obtain merchant promotional information which reflects promotional advertisements merchant 131 wishes to offer to consumers at the geolocation.

Recommendation engine 413 may obtain consumer related information including, consumer demographic information, consumer preferences including types, categories and/or other such information related to products and/or services consumer may be interested in, consumer 121 provided answers, consumer social media information related to consumer's social media accounts on one or more social media platforms, from one or more of databases 407-411. For example, recommendation engine 413 may obtain consumer information from consumer database 407, which can provide all types of goods and/or services consumers may be interested in. Recommendation engine 413 may selectively obtain consumer behavioral information from consumer behavioral information database 409. Recommendation engine 413 can obtain consumer historical information associated with the consumer form consumer historical database 411.

Recommendation engine 413 can compare types of goods and/or services a consumer may be interested in (e.g., consumer information from consumer database 407) with consumer preferences data obtained from one or more social media platforms (e.g., behavioral information from consumer behavioral information database 409) and previously accepted promotional offers by the consumer (e.g., historical information associated with the consumer form consumer historical database 411) with which promotional advertisements merchant 131 wishes to offer consumers at the geolocation (e.g., promotional information from merchant database 403) to determine whether a promotional advertisement provided by merchant 131 should be recommended to consumer 121. Such recommendations can be determined from an overall consumer perspective, e.g., by comparing types of consumer preferred goods and/or services with types of promotional advertisements provided by a merchant, or a more granular perspective, i.e., whether or not a consumer has shown a preference that was not indicated directly by the consumer but rather one that can be obtained by analyzing consumer behavioral information. For example, historical content information can be correlated to consumer behavioral information. That is, recommendation engine 413 may determine whether or not the promotional offer impacts consumer. For example, recommendation engine 413 may determine that promotional advertisements related to a sale at a bakery café should not be recommended to a consumer that while indicated they like sweets has recently posted messages on their social media platform about starting to follow a healthier lifestyle.

Recommendation engine 413 may forward the aforementioned recommendations to notification engine 417 to be reported to one or more consumers, merchants, and/or recommendation platform 107. Notification engine 417 may present recommendations as selectable options via some user interface accessible by consumer 121 (as will be discussed in greater detail below).

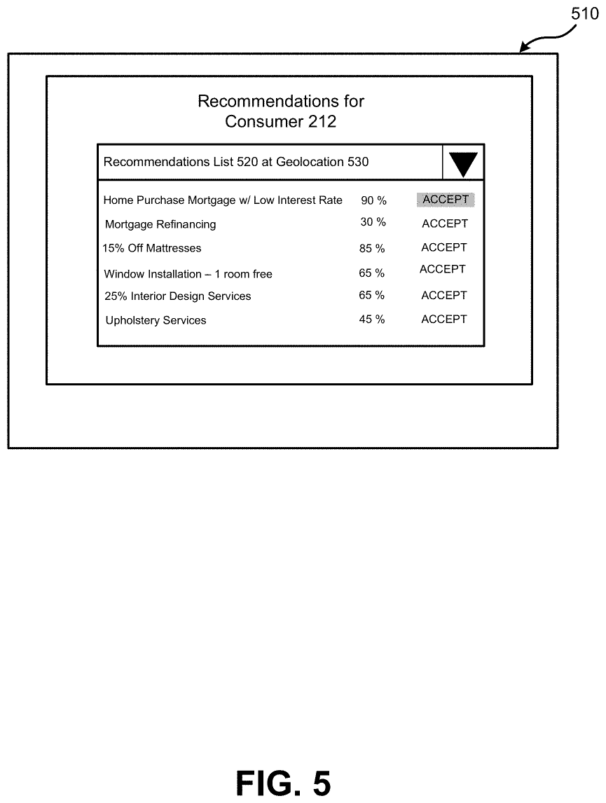

FIG. 5 illustrates an example graphical user interface (“GUI”) 510. GUI 510 may be presented to one or more consumers, e.g., consumer 121, that have a consumer account on recommendation platform 107 consumer merchants, e.g., merchant 131, that have a merchant account on recommendation platform 107. Consumer 121 may access recommendation platform 107 via GUI 510 on a mobile computing device, identified as mobile computing device 125 in FIG. 1. GUI 510 may be implemented as part of a webpage “dashboard” and/or separate application accessible by consumer 121 and merchant 131. In the context of this disclosure, a dashboard can refer to a collation of information about one or more merchants.

As previously discussed with respect to FIG. 4, notification engine 417 may output recommendations generated by recommendation engine 413. One or more of these generated recommendations may be presented to consumer 212 at geolocation 530 via recommendation drop-down list 520 as selectable options. For example, each selectable option may correspond to a particular recommendation. Consumer 121 may choose to accept a recommendation by selecting to accept the recommendation.

It should be noted that recommendations themselves may be tiered, where recommendations may be generated and presented to consumer 121 in terms of estimated value levels. For example, a first set of recommendations may be generated and presented to consumer 121, where this first set may be predicted to bring value to consumer 121 at a level of, e.g., 95 percent. A second set of recommendations may be generated and presented to consumer 121, where this second set may include less valuable recommendations. This second set of recommendations may be predicted to bring value to consumer 121 at a level of, e.g., 20 percent. Depending, for example, on the value level desirable to consumer 121, consumer 121 may select an appropriate recommendation set.

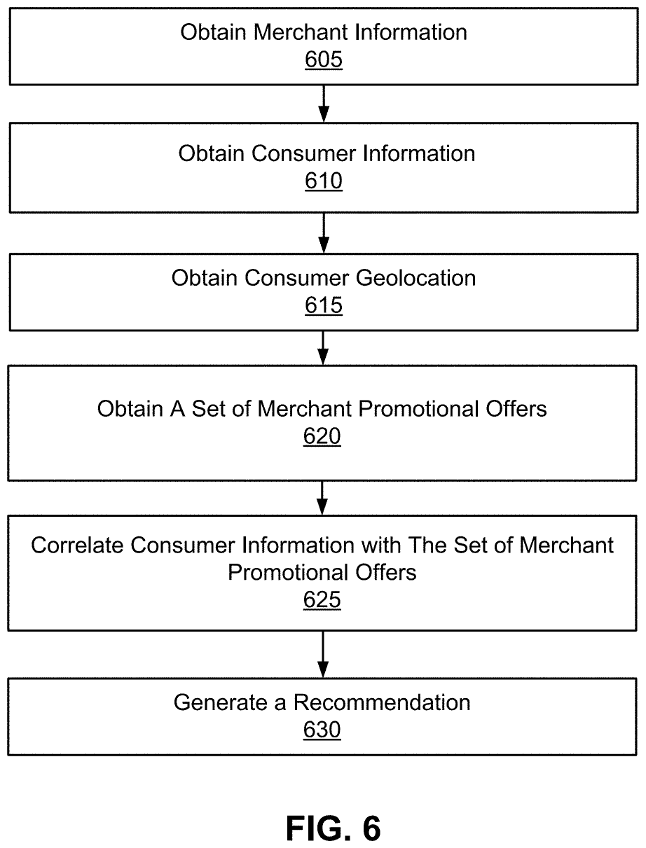

FIG. 6, illustrates a flow chart describing various processes that can be performed in order to provide recommendations in accordance with one embodiment. At operation 605, merchant information associated with a merchant is obtained. As described previously, merchant information may comprise data characterizing one or more of a merchant, types of products and services offered by the merchant, promotional advertisements provided by the merchant, one or more attributes of the consumer the merchant is interested in distributing its promotional advertisements to, and a geolocation for which the promotional offer is valid for, etc. At operation 610, consumer information associated with a consumer is obtained. As described previously, consumer information may comprise data characterizing one or more of a consumer, types or categories of products and services that consumers may be interested in, types or levels of promotional advertisements, specific merchants consumers may be interested in, and a geolocation of consumers receiving recommendations. At operation 615, geolocation information associated with a geolocation of a consumer is obtained. At operation 620, a set of promotional offers for the merchant at the geolocation of consumer may be obtained. At operation 625, the consumer information associated with the consumer and the set of promotional offers for the merchant may be correlated. For example, the value levels that may be applicable to the consumer can be determined from current or historical data. For example, consumer demographic information can be paired with consumer behavioral information indicative of, e.g., the merchant engagement frequency, or potential likelihood of merchant engagement. At operation 630, recommendations can be generated based on the correlations between the consumer information associated with a consumer and the set of promotional offers for each merchant.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method of providing recommendations based on user geolocation in a client application utilizing the user information, the method comprising:
obtaining user information, the user information including demographic information of a user and preference information of the user, such that the demographic information indicating demographic characteristics of the user and the preference information indicating at least one user selected product category;
obtaining behavioral and social information of the user based the demographic characteristics of the user and the at least one user selected product category;
obtaining geolocation information, the geolocation information indicating a geolocation of the user;
obtaining promotional information associated with one or more merchants at the geolocation of the user, the promotional information including at least one merchant promotional event;
determining one or more user promotional events by analyzing the at least one merchant promotional event associated with the one or more merchants at the geolocation of the user and the at least one user selected product category;
generating a set of recommendations based on the plurality of user promotional events, the set of recommendations representing a subset of the of user promotional events; and
presenting the set of recommendations within a graphical interface of an application.

2. The method of claim 1, further comprising determining a set of value estimates for each of the one or more user promotional events.

3. The method of claim 2, wherein the set of value estimates for each of the one or more user promotional events is determined based on at least one of the preference information and the user behavioral and social information.

4. The method of claim 2, further comprising ordering the one or more user promotional events, such that each of the one or more user promotional events is ordered based on an order specified by the set of value estimates, wherein individual user promotional events that have a determined higher value estimate are given a higher order number than the individual user promotional events that do not.

5. The method of claim 1, further comprising generating a notification comprising the set of recommendations.

6. The method of claim 4, further comprising determining at least one extrinsic preference using the behavioral and social information of the user.

7. The method of claim 6, wherein the merchant promotional event includes at least one of a promotional event category and promotional event data.

8. The method of claim 7, wherein determining the plurality of user promotional events is performed by analyzing the promotional category and promotional event details of the one or more promotional events associated with the one or more merchants at the geolocation of the user and the at least one extrinsic preference.

9. The method of claim 1, wherein the behavioral and social information of the user is obtained via one or more social media account specified by the user.

10. The method of claim 1, wherein the demographic characteristics include at least one or more of the user's age, sex, and/or race.

11. A system configured to analyze user information and provide recommendations based on user geolocation in a client application utilizing the user information, the system comprising:
one or more physical processors configured by machine-readable instructions to:
obtain user information, the user information including demographic information of a user and preference information of the user, such that the demographic information indicating demographic characteristics of the user and the preference information indicating at least one user selected product category;
obtain behavioral and social information of the user based on the demographic characteristics of the user and the at least one user selected product category;
obtain geolocation information, the geolocation information indicating a geolocation of the user;
obtain promotional information associated with one or more merchants at the geolocation of the user, the promotional information including at least one merchant promotional event;
determine at least one of user promotional event by analyzing the one or more merchant promotional events associated with the one or more merchants at the geolocation of the user and the at least one user selected product category;
generate a set of recommendations comprising the at least one or more user promotional event; and
present the set of recommendations within a graphical interface of an application.

12. The system of claim 11, wherein the one or more physical processors are further configured by machine-readable instructions to determine a set of value estimates for each of the one or more user promotional events.

13. The system of claim 11, wherein the set of value estimates for each of the one or more user promotional events is determined based on at least one of the preference information and the user behavioral and social information.

14. The system of claim 12, wherein the one or more physical processors are further configured by machine-readable instructions to:
order the one or more user promotional events, such that each of the one or more user promotional events is ordered based on an order specified by the set of value estimates, wherein individual user promotional events that have a determined higher value estimate are given a higher order number than the individual user promotional events that do not.

15. The system of claim 14, wherein the set of recommendations are ordered based on the ordered one or more user promotional events, the order of individual recommendations reflecting a likelihood the user may accept the individual recommendation.

16. The system of claim 11, wherein the one or more physical processors are further configured by machine-readable instructions to generate a notification comprising the set of recommendations.

17. The system of claim 11, wherein the merchant promotional event includes at least one of a promotional event category and promotional event data.

18. The system of claim 17, wherein the one or more physical processors are further configured by machine-readable instructions to determine at least one extrinsic preference using the behavioral and social information of the user.

19. The system of claim 18, wherein determining the plurality of user promotional events is performed by analyzing the promotional category and promotional event details of the one or more merchant promotional events associated with the one or more merchants at the geolocation of the user and the at least one extrinsic preference.

20. The system of claim 11, wherein the behavioral and social information of the user is obtained via one or more social media account specified by the user.

21. The system of claim 11, wherein the demographic characteristics include at least one or more of the user's age, sex, and/or race.
